(19) United States
(12) Patent Application Publication
(10) Pub. No.: US 2007/0279913 A1
(43) Pub. Date: Dec. 6, 2007

(54) Light beam redirecting apparatus

(76) Inventor: Robert R. Kelly, Merlin, OR (US)

Correspondence Address: GERALD D. HAYNES, 2 NORTH OAKDALE AVENUE, MEDFORD, OR, 97501, US

(21) Appl. No.: 11/510,341

(22) Filed: Aug. 25, 2006

Related U.S. Application Data
(60) Provisional application No. 60/810,465, filed on Jun. 1, 2006.

(51) Int. Cl. F21V 7/00

(52) U.S. Cl. 362/341

(57) ABSTRACT

A light beam redirecting apparatus is disclosed. In an illustrative embodiment, the light beam redirecting apparatus includes an aperture housing, a light module provided in the aperture housing, at least one reflective surface provided in the aperture housing adjacent to the light module, an aperture tunnel provided in the aperture housing adjacent to the at least one reflective surface and a tunnel opening provided in the aperture housing and communicating with the aperture tunnel.

### CROSS-REFERENCE TO RELATED APPLICATIONS

This application claims the benefit of U.S. Provisional application No. 60/810,465, filed Jun. 1, 2006, by Robert R. Kelly, who is also the inventor of the invention shown and described herein.

### 1. FIELD OF THE INVENTION

My invention relates to laser arbor saw guides. More particularly, it relates to a light beam redirecting apparatus which is particularly adapted to redirect a light beam parallel to or within an adjacent or shared saw plane to enhance saw blade guiding accuracy.

### 2. DESCRIPTION OF THE RELATED ART

The semiconductor laser, because of its small size, convenient means for powering, and narrow beam, has found numerous applications for purposes of making and measuring work pieces. For example, in my earlier patent, U.S. Pat. No. 5,862,727, issued Jan. 26, 1999, I teach an apparatus and method for visibly displaying lines on a work piece along which a cut is to be made in the operation of a rotary saw. More particularly I describe lasers that are mounted adjacent to and rotate with the saw blades. The radial acceleration produced in rotating the blade switches the laser on. In FIG. 14 of the drawings, I provide an example of a laser arbor saw guide 70, similar to those described in my '727 patent. The guide 70 is adapted to be mounted on a saw blade shaft 74 adjacent to a saw blade 72 of a rotary saw. The laser arbor saw guide 70 contains a light source (not illustrated) such as an LED module. A light-emitting aperture (not illustrated) is provided in the edge of the laser arbor saw guide 70. A light beam 71 emitted by the light source exits the laser arbor saw guide 70 through the light-emitting aperture and impinges on a work surface 75 which is to be cut by the saw blade 72. Accordingly, the light beam 71 forms a guide line (not illustrated) on the work surface 50 which indicates a cutting path for the saw blade 72.

In the conventional laser arbor saw guide 70, the light-emitting aperture (not illustrated) is typically located about 0.03 of an inch away from the plane 73 of the saw blade 72. The emitted light beam 71 must therefore be angled toward the cutting edge of the saw blade 72 to intersect with the plane 73 of the saw blade 72 at the work surface 75. Consequently, the guide line which is cast on the work surface 75 by the light beam 71 has a slight curve and moves laterally on both sides of the saw blade 72 when the rotating saw blade 72 is moved toward or away from the work surface 75. This obscures the desired cutting path of the saw blade 72, resulting in an inaccurate cut in the work surface 75.

In sum, a need remains for an apparatus and method for redirecting a light beam parallel to or within an adjacent or shared saw plane to enhance saw blade guiding accuracy. Accordingly, an object of my invention is to provide such an apparatus and method.

### SUMMARY OF THE INVENTION

My invention provides a light beam redirecting apparatus and method. An illustrative embodiment of the light beam redirecting apparatus includes an aperture housing, a light module provided in the aperture housing, at least one reflective surface provided in the aperture housing adjacent to the light module, an aperture tunnel provided in the aperture housing adjacent to the at least one reflective surface and a tunnel opening provided in the aperture housing and communicating with the aperture tunnel.

In an alternative embodiment, my invention provides a light beam redirecting apparatus that includes an aperture housing; a light module provided in the aperture housing; a rhomboid optic provided in the aperture housing and having a first reflective surface spaced-apart with respect to said light module, a second reflective surface disposed in substantially perpendicular relationship with respect to the first reflective surface and a passive surface adjacent to the second reflective surface; an aperture tunnel provided in the aperture housing adjacent to the passive surface of the rhomboid optic; and a tunnel opening provided in the aperture housing and communicating with the aperture tunnel.

In an another preferred embodiment, my invention provides a light beam redirecting apparatus that includes an aperture housing; a light module provided in the aperture housing; a rhomboid optic provided in the aperture housing and having a first passive surface adjacent to the light module, a first reflective surface adjacent to the first passive surface, a second reflective surface disposed in substantially perpendicular relationship with respect to the first reflective surface and a second passive surface adjacent to the second reflective surface; an aperture tunnel provided in the aperture housing adjacent to the second passive surface of the rhomboid optic; and a tunnel opening provided in the aperture housing and communicating with the aperture tunnel.

In another preferred embodiment, my invention provides a method of redirecting a beam of light during the operation of a rotary saw blade, including providing a light beam redirecting apparatus mounted on the that rotary saw blade and rotating therewith, including an aperture housing, a light module provided in the aperture housing, a rhomboid optic provided in the aperture housing, and an aperture tunnel provided in the aperture housing adjacent to the rhomboid optic, and a tunnel opening provided in the aperture housing and communicating with the aperture tunnel; emitting a beam of light from the light module; and transmitting the beam of light through the rhomboid optic wherein the rhomboid optic deflects the light beam such that the light beam is transmitted through the aperture tunnel substantially disposing the light beam in a parallel relationship with respect to the plane of the saw blade thereby forming a substantially straight and un-obscured guide line on a work surface located adjacent to the saw blade.

### BRIEF DESCRIPTION OF THE DRAWINGS

I will now describe my invention, by way of example, with reference to the accompanying drawings, in which:

FIG. 1 is a side view of an illustrative embodiment of the light beam redirecting apparatus;

FIG. 2 is an opposite side view of an illustrative embodiment of the light beam redirecting apparatus;

FIG. 3 is a perspective view of an illustrative embodiment of the light beam redirecting apparatus;

FIG. 4 is a perspective view of an illustrative embodiment of the light beam redirecting apparatus, more particularly illustrating a typical light beam transmission pathway (shown in phantom) in the apparatus;

FIG. 5 is an enlarged, sectional view of an aperture housing element of the light beam redirecting apparatus, with the cover element removed from the aperture housing, more particularly illustrating transmission of a light beam from a light source and through a rhomboid optic and an aperture tunnel (shown in phantom), respectively, provided in the aperture housing;

FIG. 6 is an edge view of an illustrative embodiment of the light beam redirecting apparatus, more particularly illustrating a typical transmission pathway for a light beam (shown in phantom) as it is emitted from a light module and passes through a rhomboid optic and exits the aperture housing through an aperture tunnel;

FIG. 7 is an enlarged sectional view of the aperture housing element of an illustrative embodiment of the light beam redirecting apparatus, with the cover element removed from the aperture housing, more particularly illustrating a typical transmission pathway for a light beam as it is emitted from a light module and passes through a rhomboid optic and an aperture tunnel, respectively, in the aperture housing;

FIG. 8 is a perspective view of a rhomboid optic element of an illustrative embodiment of the light beam redirecting apparatus, more particularly illustrating a typical transmission pathway of a light beam (shown in phantom) as it passes through the rhomboid optic;

FIG. 9 is an edge view of an illustrative embodiment of the light beam redirecting apparatus, mounted on a blade shaft (in section) adjacent to a rotary saw blade provided on the blade shaft and more particularly illustrating a light beam emitted from the apparatus in adjacent, parallel relationship with respect to a plane of the saw blade and impinging on a work surface;

FIG. 10 is a top view of an illustrative embodiment of the light beam redirecting apparatus, provided on a surface plate and more particularly illustrating a light beam emitted from the apparatus in parallel and adjacent relationship with respect to the surface plate and against a target face;

FIG. 11 is a side view of an illustrative embodiment of the light beam redirecting apparatus, provided on the surface plate illustrated in FIG. 10 and more particularly illustrating a light beam emitted from the apparatus in parallel and adjacent relationship with respect to the surface plate and against a target face;

FIG. 12 is an enlarged sectional view of an aperture housing element of an alternative illustrative embodiment of the light beam redirecting apparatus, more particularly illustrating an angled reflective surface provided in the aperture housing and a light beam emitted from a light module in the aperture housing and deflected by the angled reflective surface in a perpendicular transmission pathway in adjacent relationship with respect to a plane of a saw blade;

FIG. 13 is an enlarged sectional view, taken along section line 13 in FIG. 11; and

FIG. 14 is an edge view of a typical conventional laser arbor saw guide, mounted on a blade shaft (in section) adjacent to a rotary saw blade provided on the blade shaft and more particularly illustrating a light beam emitted from the apparatus in angular relationship with respect to a plane of the saw blade and impinging on a work surface.

### DETAILED DESCRIPTION OF THE INVENTION

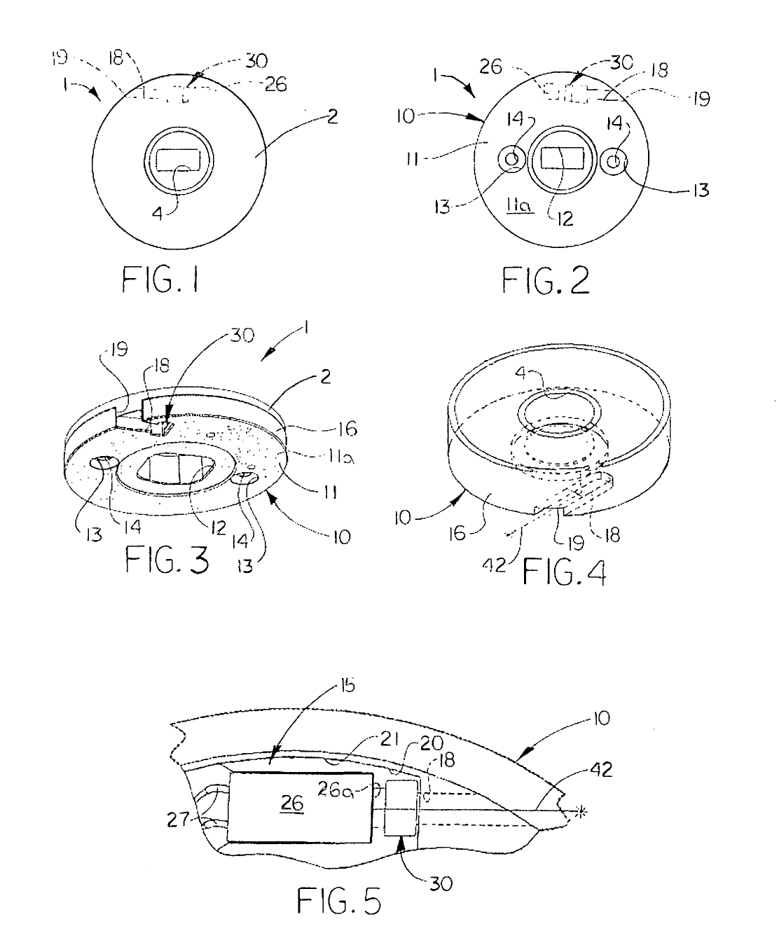

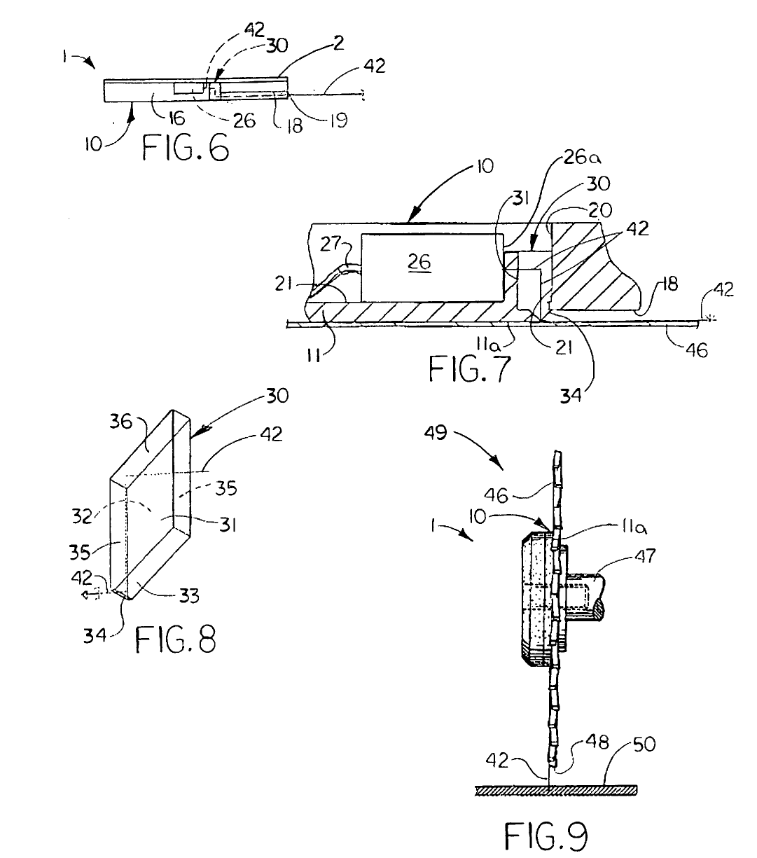

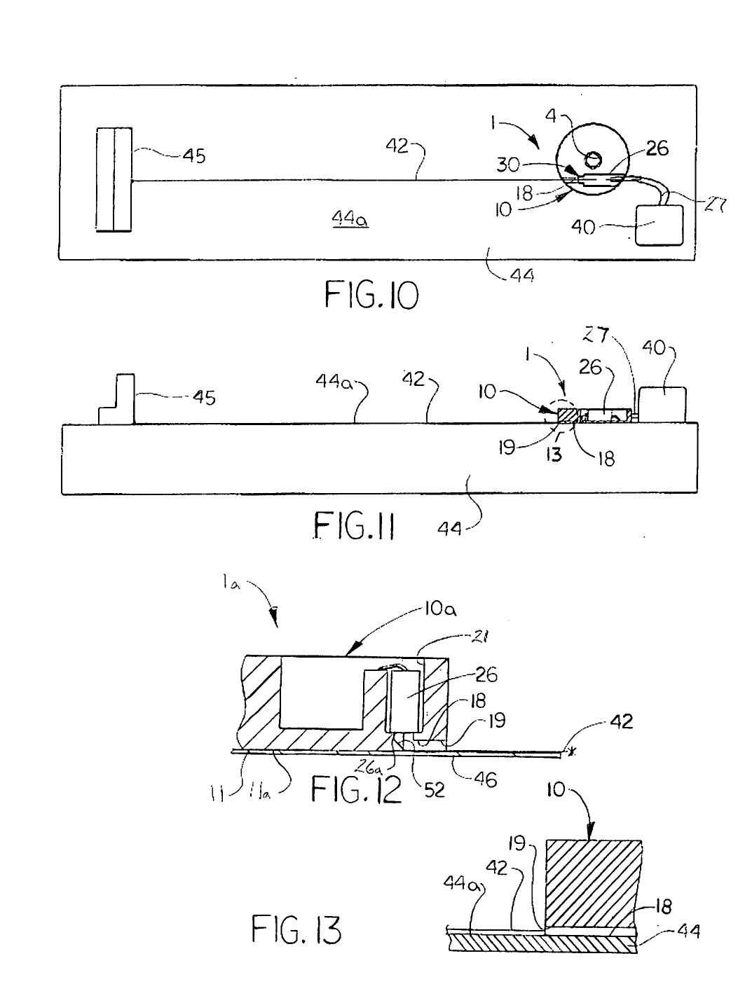

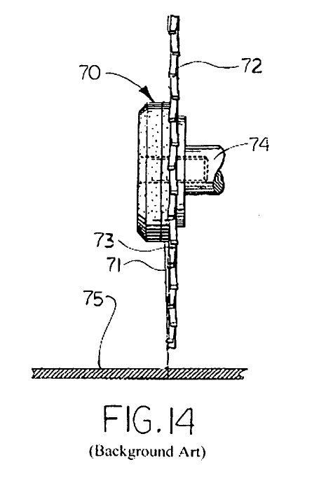

My invention provides a light beam redirecting apparatus. Referring initially to FIGS. 1-8 of the drawings, I describe an illustrative embodiment of the light beam redirecting apparatus, which I will hereafter refer to as “apparatus”, is generally indicated by reference numeral 1. The apparatus 1 includes an aperture housing 10. The aperture housing 10 includes a circular housing plate 11 having a housing plane 11a. An annular housing wall 16 extends from the housing plate 11. I provide a circular cover 2 on the housing wall 11 and closes a housing interior 15 (FIG. 5) of the aperture housing 10. As I illustrate in FIG. 3, housing fasteners 14 may be extended through respective fastener openings (not illustrated) provided in the housing plate 11 and the cover 2, respectively, to detachably secure the cover 2 to the aperture housing 10. The housing fasteners 14 may be seated in respective fastener cavities 13 provided in the housing plate 11.

I will now and hereafter describe the aperture housing 10 and cover 2 protect the interior components of the apparatus 1, from an exterior work environment. As I further illustrate in FIG. 3, a saw blade shaft opening 12 extends through approximately the center of the housing plate 11 of the aperture housing 10 and communicates with an aligned or registering saw blade shaft opening 4 (FIG. 1) which extends through approximately the center of the cover 2.

As I illustrate in FIGS. 1-4, my invention provides an elongated aperture tunnel 18 in the housing plate 11 of the aperture housing 10, typically adjacent to the housing wall 16. The longitudinal axis of the aperture tunnel 18 extends parallel to or within the plane of the aperture housing 10. The aperture tunnel 18 communicates with a tunnel opening 19 which extends through the housing wall 16 of the aperture housing 10.

As illustrated in FIGS. 5 and 7, my invention provides an optic compartment 20 in the aperture housing 10, adjacent to the aperture tunnel 18. I provide a light module compartment 21 in the aperture housing 10, adjacent to the optic compartment 20. I provide a light module 26, having a light-emitting end 26a, in the light module compartment 21. The light module 26 may be any type of light source which is capable of emitting a concentrated light beam 42 such as, for example, a laser diode; a light emitting diode (LED); or a laser diode module. I connect the light module 26 to a suitable power supply 40 (FIGS. 10 and 11) typically via module wiring 27. A centrifugal switch (not illustrated) may be provided in the aperture housing 10 and connected between the power supply 40 and the light module 26 to facilitate operation of the light module 26 responsive to rotation of the apparatus 1, as I will hereafter describe. The aperture housing 10 and interior circuitry may be that of a laser arbor saw guide housing such as that I disclosed in U.S. Pat. No. 5,862,727, which I incorporate by reference herein in its entirety.

My invention provides a rhomboid optic 30 in the optic compartment 20 of the aperture housing 10. As I illustrate in FIG. 8, the rhomboid optic 30 includes a first passive surface 31 and a first reflective surface 32 which I dispose in substantially parallel, adjacent, spaced-apart relationship with respect to the first passive surface 31. I dispose a second reflective surface 33 in substantially perpendicular relationship with respect to the first reflective surface 32. A second passive surface 34 extends adjacent to the second reflective surface 33. The rhomboid optic 30 may further include parallel, spaced-apart side surfaces 35 and an end surface 36 which I dispose in substantially parallel, spaced-apart relationship with respect to the second reflective surface 33.

As I illustrate in FIG. 7, when I seat the rhomboid optic 30 in the optic compartment 20, the first passive surface 31 of the of the rhomboid optic 30 is disposed adjacent to the light-emitting end 26a of the light module 26, whereas the second passive surface 34 of the rhomboid optic 30 is disposed adjacent to the aperture tunnel 18. Accordingly, as I illustrate in FIG. 8, the light beam 42 emitted by the light module 26 is transmitted through the first passive surface 31 and strikes the first reflective surface 32 of the rhomboid optic 30. At the first reflective surface 32, the path of the light beam 42 is deflected substantially 90 degrees toward the second reflective surface 33 of the rhomboid optic 30. The light beam 42 strikes the second reflective surface 33 and is again deflected substantially 90 degrees toward and through the second passive surface 34 of the rhomboid optic 30. As I illustrate in FIG. 7, the light beam 42 thus exits the rhomboid optic 30 through the second passive surface 34 thereof and is transmitted through the aperture tunnel 18 and emerges from the tunnel opening 19, as I show in FIG. 4. As I illustrate in FIG. 7, the position of the second passive surface 34 of the rhomboid optic 30 is such that the emitted light beam 42 is disposed at a spacing of about 0.005 inch with respect to the housing plane 11a of the housing plate 11.

Referring next to FIGS. 10, 11 and 13 of the drawings, I show the apparatus 1 mounted on a planar surface plate 44. My invention provides a target face 45 on the surface plate 44 in spaced-apart relationship with respect to the apparatus 1. I dispose the target face 45 at a substantially 90-degree angle with respect to the plane 44a of the surface plate 44. Accordingly, as I illustrate in FIG. 13, the light beam 42 is emitted from the aperture tunnel 18 of the apparatus 1 in substantially parallel, adjacent relationship with respect to the plane 44a of the surface plate 44. I dispose the light beam 42 at a spacing of typically about 0.005 inch with respect to the plane 44a of the surface plate 44. The light beam 42 impinges against the target face 45 at a substantially 90-degree angle with respect to the target face 45, as I illustrate in FIG. 10.

Referring next to FIGS. 4, 6, 7 and 9 of the drawings, in typical use, I mount the apparatus 1 on a blade shaft 47 of a rotary saw 49 typically by extending the blade shaft 47 through the saw blade shaft opening 12 (FIG. 3) of the aperture housing 10 and the registering saw blade shaft opening 4 of the cover 2 (FIG. 1) and fastening the apparatus 1 on the blade shaft 47 using techniques which are known to me and by those skilled in the art. I position the saw blade 46 above a work surface 50 which is to be cut by the saw blade 46. When I mount the apparatus 1 on the blade shaft 47, the housing plane 11a of the housing plate 11 on the aperture housing 10 engages the saw blade 46 of the rotary saw 49, as I illustrate in FIG. 7.

During operation of the rotary saw 49, the apparatus 1 rotates with the blade shaft 47 and the saw blade 46. Accordingly, the light module 26 emits the light beam 42, typically responsive to the effects of centrifugal force on the centrifugal switch (not illustrated) which establishes electrical contact between the power supply 40 (FIGS. 10 and 11) and the light module 26. Consequently, the light beam 42 is transmitted through the rhomboid optic 30, which deflects the transmission path of the light beam 42 such that the light beam 42 is transmitted through the aperture tunnel 18 and emerges from the tunnel opening 19 of the aperture tunnel 18, as I illustrate in FIGS. 4 and 6. As it emerges from the tunnel opening 19, the light beam 42 is disposed in substantially parallel relationship with respect to the plane of the saw blade 46, as illustrated in FIGS. 7 and 9. The light beam 42 is disposed at a spacing of typically about 0.005 inch with respect to the plane of the saw blade 46. As I further illustrate in FIG. 9, the light beam 42 impinges on the work surface 50 at a substantially 90-degree angle with respect to the plane of the work surface 50. Furthermore, the light beam 42 forms a substantially bright, sharp, accurate, straight and un-obscured guide line (not illustrated) on the work surface 50 which is located adjacent to or within the cutting plane of the saw blade 46 since the guide line is disposed immediately adjacent to the saw blade kerf 48 at the work surface 50. This facilitates accurate and precise cutting of the work surface 50 in a straight line along the guide line.

Referring next to FIG. 12 of the drawings, in an alternative illustrative embodiment of the light beam redirecting apparatus 1a, my invention provides a reflective surface 52, such as a mirror, for example, in the light module compartment 21 of the aperture housing 10a, adjacent to the aperture tunnel 18. I dispose the plane of the reflective surface 52 at a substantially 45-degree angle with respect to the housing plane 11a of the housing plate 11 and with respect to the longitudinal axis of the tunnel opening 19. I situate the light module 26 in the light module compartment 21 such that the light-emitting end 26a of the light module 26 is disposed in adjacent and spaced-apart relationship with respect to the reflective surface 52. Accordingly, the light beam 42 is emitted from the light module 26 and strikes the reflective surface 52, which deflects the light beam 42 in a substantially 90-degree angle through the aperture tunnel 18 and tunnel opening 19, respectively.

I typically use the light beam reflecting apparatus 1a is as I previously described with respect to the apparatus 1 in FIG. 9. Accordingly, I position the light-emitting end 26a of the light module 26 with respect to the reflective surface 52 in such a manner that the deflected light beam 42 travels in substantially parallel relationship with respect to the saw blade 46 and at a spacing of typically about 0.005 inch with respect to the plane of the saw blade 46. Therefore, the light beam 42 forms a substantially straight and un-obscured guide line (not illustrated) on a work surface (not illustrated) which is located adjacent to or within the cutting plane of the saw blade 46, thereby facilitating accurate and precise cutting of the work surface in a straight line along the guide line.

While I have described the preferred embodiments of my invention above, persons of ordinary skill in the art will recognize and understand that various modifications can be made in my invention and the appended claims are intended to cover all such modifications which may fall within the spirit and scope of the invention. I claim all modifications coming within the spirit and scope of the accompanying claims.

I claim:

1. A light beam redirecting apparatus, comprising:
an aperture housing having a housing wall;
a light module provided in the aperture housing;
at least one reflective surface provided in the aperture housing in spaced-apart relationship with respect to the light module;
an aperture tunnel provided in the aperture housing adjacent to the at least one reflective surface; and
a tunnel opening provided in the housing wall and communicating with the aperture tunnel.

2. The apparatus of claim 1 wherein the housing wall is generally cylindrical and further comprising a generally circular housing plate provided on the housing wall.

3. The apparatus of claim 1 wherein the at least one reflective surface comprises a mirror disposed at a substantially 45-degree angle with respect to the aperture tunnel.

4. The apparatus of claim 1 further comprising a cover provided on the housing wall.

5. The apparatus of claim 1 further comprising a saw blade shaft opening provided in the aperture housing.

6. The apparatus of claim 1 wherein the light module comprises a laser diode.

7. The apparatus of claim 1 wherein the light module comprises a light emitting diode.

8. The apparatus of claim 1 wherein said light module comprises a laser diode module.

9. A light beam redirecting apparatus, comprising:
an aperture housing;
a light module provided in the aperture housing;
a rhomboid optic provided in the aperture housing and having a first reflective surface spaced-apart with respect to said light module, a second reflective surface disposed in substantially perpendicular relationship with respect to the first reflective surface and a passive surface adjacent to the second reflective surface;
an aperture tunnel provided in the aperture housing adjacent to the passive surface of the rhomboid optic; and
a tunnel opening provided in the aperture housing and communicating with the aperture tunnel.

10. The apparatus of claim 9 wherein the aperture housing comprises a housing plate and an annular housing wall extending from the housing plate, and wherein the aperture tunnel extends through said housing plate and the tunnel opening extends through the housing wall.

11. The apparatus of claim 10 further comprising a cover carried by the housing wall.

12. The apparatus of claim 9 further comprising a saw blade shaft opening provided in the aperture housing.

13. The apparatus of claim 9 wherein the light module comprises a laser diode.

14. The apparatus of claim 9 wherein the light module comprises a light emitting diode.

15. The apparatus of claim 9 wherein the light module comprises a laser diode module.

16. A light beam redirecting apparatus, comprising:
an aperture housing;
a light module provided in the aperture housing;
a rhomboid optic provided in the aperture housing and having a first passive surface adjacent to the light module, a first reflective surface adjacent to the first passive surface, a second reflective surface disposed in substantially perpendicular relationship with respect to the first reflective surface and a second passive surface adjacent to the second reflective surface;
an aperture tunnel provided in the aperture housing adjacent to the second passive surface of said rhomboid optic; and
a tunnel opening provided in the aperture housing and communicating with the aperture tunnel.

17. The apparatus of claim 16 wherein the aperture housing comprises a housing plate and an annular housing wall extending from said housing plate, and wherein the aperture tunnel extends through the housing plate and the tunnel opening extends through the housing wall.

18. The apparatus of claim 16 wherein the light module comprises a laser diode.

19. The apparatus of claim 16 wherein the light module comprises a light emitting diode.

20. The apparatus of claim 16 wherein the light module comprises a laser diode module.

21. A method of redirecting a beam of light during the operation of a rotary saw blade, comprising the steps of:
providing a light beam redirecting apparatus mounted on the that rotary saw blade and rotating therewith, including an aperture housing, a light module provided in the aperture housing, a rhomboid optic provided in the aperture housing, and an aperture tunnel provided in the aperture housing adjacent to the rhomboid optic, and a tunnel opening provided in the aperture housing and communicating with the aperture tunnel;
emitting a beam of light from the light module; and
transmitting the beam of light through the rhomboid optic wherein the rhomboid optic deflects the light beam such that the light beam is transmitted through the aperture tunnel substantially disposing the light beam in a parallel relationship with respect to the plane of the saw blade thereby forming a substantially straight and un-obscured guide line on a work surface located adjacent to the saw blade.

22. The method of claim 21, wherein the rhomboid optic comprises a first passive surface adjacent to the light module, a first reflective surface adjacent to the first passive surface, a second reflective surface disposed in substantially perpendicular relationship with respect to the first reflective surface and a second passive surface adjacent to the second reflective surface.

23. The method of claim 21, wherein the light module comprises a laser diode.

24. The method of claim 21, wherein the light module comprises a light emitting diode.

25. The method of claim 21, wherein the light module comprises a laser diode module.

26. The method of claim 21, wherein the aperture housing comprises a housing plate and an annular housing wall extending from said housing plate, and wherein the aperture tunnel extends through the housing plate and the tunnel opening extends through the housing wall.

27. The method of claim 21, wherein the substantially disposed light beam comprises a spacing of about 0.005 inch with respect to the plane of the saw blade.
